(19) United States
(12) Patent Application Publication
(10) Pub. No.: US 2009/0136098 A1
(43) Pub. Date: May 28, 2009

(54) CONTEXT SENSITIVE PACING FOR EFFECTIVE RAPID SERIAL VISUAL PRESENTATION

(75) Inventors: Santosh Mathan, Minneapolis, MN (US); Patricia M. Ververs, Ellicott City, MD (US); Deniz Erdogmus, Beaverton, OR (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/945,653

(22) Filed: Nov. 27, 2007

(51) Int. Cl. G06K 9/00

(52) U.S. Cl. 382/128

(57) ABSTRACT

A system and method of efficiently and effectively triaging an image that may include one or more target entities are provided. The image is divided into a plurality of individual image chips that each have a determinable image complexity. The image complexity of each image chip is determined, and each image chip is successively displayed to a user for a presentation time period that, for each image chip, varies based on the determined image complexity of the image chip.

### STATEMENT REGARDING FEDERALLY SPONSORED RESEARCH OR DEVELOPMENT

This invention was made with Government support under contract HM1582-05-C-0046 awarded by the Defense Advanced Research Projects Agency (DARPA). The Government has certain rights in this invention.

### TECHNICAL FIELD

The present invention generally relates to a system and method for efficiently conducting image triage and, more particularly, to a system and method for conducting high speed image triage using image pacing based on the complexity of presented images.

### BACKGROUND

Analysts in various professions may, at times, be called upon to search relatively large collections of imagery to identify, if present, various types of relevant information (referred to herein as “a target entity” or “target entities”) in the collection of imagery. For example, medical analysts sometimes diagnose a physical impairment by searching complex imagery collections to identify one or more target entities therein that may be the cause of the physical impairment. Moreover, intelligence analysts may be called upon to search relatively complex imagery collections to identify target entities therein that may relate to various types of intelligence gathering activities.

Advancements in both image collection and storage technology presently allow for the relatively low-cost storage of large volumes of high-quality imagery. However, the cost of searching through large sets of imagery for target entities can often be substantial. Indeed, in many professions, such as intelligence gathering, effective searching may rely on the expertise of highly skilled analysts, who typically search through relatively large sequences of images in a relatively slow manner. Presently, the number of skilled analysts available to search the amount of imagery that is stored, or can potentially be stored, is in many instances insufficient.

In response to the foregoing, there has relatively recently been a focus on developing various systems and methods for triaging imagery. One of the methods that has shown promise combines electroencephalography (EEG) technology and rapid serial visualization presentation (RSVP). Various implementations of this combination have been researched and developed. For example, researchers have experimented with a system in which users are presented, using the RSVP paradigm, a sequence of images, some of which may include particular types of target entities. During the RSVP presentation, EEG data are collected from the users. A classifier then uses the collected EEG data to assign probabilities to each image. The probabilities are representative of the likelihood an image includes a target.

Although useful in sorting a sequence of images, the above described system and method, as well as other systems and methods that employ these same technologies, do suffer certain drawbacks. For example, the likelihood that a user correctly identifies a target in an image varies as a function of image presentation rate (e.g., image pacing) and with the image complexity of each image being presented. The image complexity of a displayed image may be thought of as the inherent signal to noise ratio of a target with respect to the surrounding context. Thus, for a given presentation time, the likelihood of detecting a target in a relatively cluttered image (e.g., an image with a relatively low signal to noise ratio) is reduced.

Hence, there is a need for an efficient and effective system and method for increasing the likelihood of target identification in images that may be relatively complex. The present invention addresses at least this need.

### BRIEF SUMMARY

In one embodiment, and by way of example only, a method of conducting image triage of an image that may include one or more target entities includes dividing the image into a plurality of individual image chips, each having a determinable image complexity. The image complexity of each image chip is determined, and each image chip is successively displayed to a user for a presentation time period that, for each image chip, varies based on the determined image complexity of at least the image chip.

In yet another exemplary embodiment, a system for conducting image triage of an image that may include one or more target entities includes a display, a data collector, and a processor. The display device is operable to receive display commands and, in response thereto, to display an image. The data collector is configured to at least selectively collect data from a user. The processor is coupled to receive the collected data from the data collector. The processor is further coupled to the display device and is configured to selectively retrieve an image, divide the image into a plurality of individual image chips that each have a determinable image complexity, determine the image complexity of each chip, and successively command the display device to display each image chip to a user for a presentation time period that, for each image chip, varies based on the determined image complexity of at least the image chip.

Furthermore, other desirable features and characteristics of the image triage system and method will become apparent from the subsequent detailed description and the appended claims, taken in conjunction with the accompanying drawings and this background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of an exemplary image triaging system;

FIG. 2 depicts an exemplary process, in flowchart form, that may be implemented by the image triaging system of FIG. 1;

FIG. 3 depicts how an image may be divided into individual image chips, in accordance with a particular embodiment of the present invention;

FIGS. 4A and 4B are exemplary image chips of differing image complexity that may be selectively displayed to a user via the system of FIG. 1; and

FIGS. 5A and 5B are exemplary pixel intensity histograms for the image chips of FIGS. 4A and 4B, respectively.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background or the following detailed description.

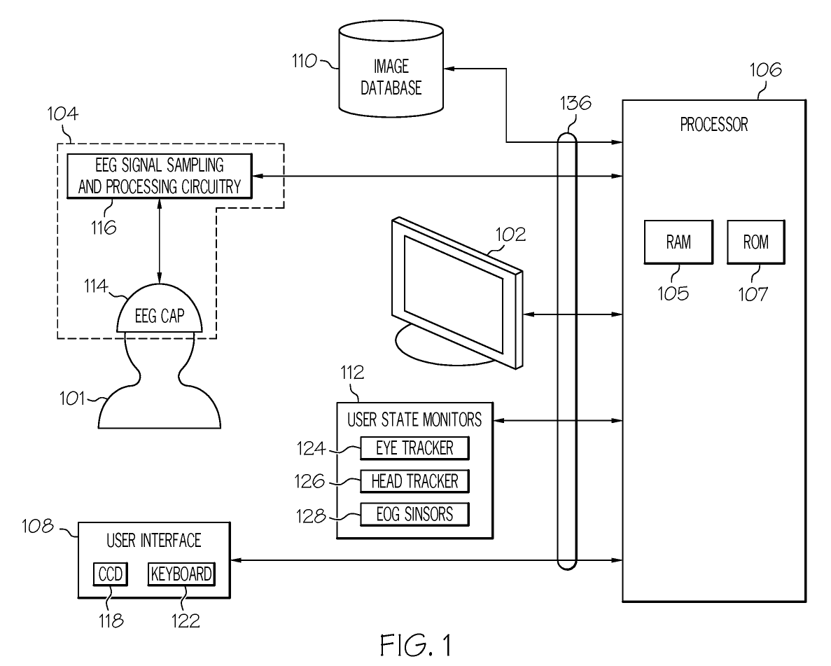

Turning first to FIG. 1, a functional block diagram of an exemplary system 100 that may be used to triage images is depicted. The depicted system 100 includes a display device 102, a data collector 104, and a processor 106. As FIG. 1 further depicts, in some embodiments the system 100 may additionally include a user interface 108, an image database 110, and one or more user state monitors 112. The display device 102 is in operable communication with the processor 106 and, in response to display commands received therefrom, displays one or more images to a user 101. It will be appreciated that the display device 102 may be any one of numerous known displays suitable for rendering graphic, icon, and/or textual images in a format viewable by the user 101. Non-limiting examples of such displays include various cathode ray tube (CRT) displays, and various flat panel displays such as, for example, various types of LCD (liquid crystal display) and TFT (thin film transistor) displays. The display may additionally be based on a panel mounted display, a head up display (HUD) projection, or any known technology.

The data collector 104 in the depicted embodiment is a neurophysiological data collector that is configured to be disposed on, or otherwise coupled to, the user 101, and is operable to selectively collect neurophysiological data from the user 101. Preferably, and as depicted in FIG. 1, the neurological data collector 104 is implemented as an electroencephalogram (EEG) system, and most preferably as a multi-channel EEG cap 114, and appropriate EEG signal sampling and processing circuitry 116. It will be appreciated that the number of EEG channels may vary. Moreover, the EEG signal sampling and processing circuitry 116 may be implemented using any one of numerous known suitable circuits and devices including, for example, one or more analog-to-digital converters (ADC), one or more amplifiers, and one or more filters. No matter the particular number of EEG channels and the particular type of EEG signal sampling and processing circuitry 116 that is used, it is in operable communication with, and is configured to supply the collected EEG data to, the processor 106. As will be described in more detail further below, the EEG signal sampling and processing circuitry 116 is further configured to receive trigger signals from the processor 106, and to record the receipt of these trigger signals concurrently with the EEG signals.

The user interface 108 is in operable communication with the processor 106 and is configured to receive input from the user 101 and, in response to the user input, supply various signals to the processor 106. The user interface 108 may be any one, or combination, of various known user interface devices including, but not limited to, a cursor control device (CCD), such as a mouse, a trackball, or joystick, and/or a keyboard, one or more buttons, switches, or knobs. In the depicted embodiment, the user interface 102 includes a CCD 118 and a keyboard 122. The user 101 may use the CCD 118 to, among other things, move a cursor symbol on the display device 102, and may use the keyboard 122 to, among other things, input various data. As will be described further below, the user 101 may additionally use either the CCD 118 or keyboard 122 to selectively supply physical response data, the purpose of which are also described further below.

The one or more user state monitors 112, if included, are operable to selectively collect various data associated with the user 101. The one or more user state monitors 112 may include at least an eye tracker 124, a head tracker 126, and one or more EOG (electrooculogram) sensors 128. The eye tracker 124, if included, is configured to detect the movement of one or both of the user's pupils. The head tracker 126, if included, is configured to detect the movement and/or orientation of the user's head. The EOG sensors 128, if included, are used to detect eye blinks and various eye movements of the user 101. Although any one of numerous devices may be used to implement the eye tracker 124 and head tracker 126, in the depicted embodiment one or more appropriately mounted and located video devices, in conjunction with appropriate processing software components are used to implement these functions. Though not explicitly depicted in FIG. 1, appropriate signal sampling and processing circuitry, if needed or desired, may be coupled between the eye tracker 124 and/or the head tracker 126 and the processor 106. Moreover, the same or similar signal sampling and processing circuitry 116 that is used with the EEG cap 114 may additionally be used to supply appropriate EOG signals to the processor 106. It will be appreciated that, at least in some embodiments, the system 100 may be implemented without one or all of the user state monitors 112. No matter which, if any, of the user state monitors 112 that are included in the system 100, each supplies appropriate user state data to the processor 106.

The processor 106 is in operable communication with the display device 102, the neurophysiological data collector 104, the user interface 108, and the image database 110 via, for example, one or more communication buses or cables 136. The processor 106 is coupled to receive neurophysiological data from the neurophysiological data collector 104. As noted above, the processor 106 may additionally receive physical response data from the user interface 108. As will be described in more detail further below, the processor 106, based at least in part on one or more of these data, assigns probabilities to discrete sections of an image. The assigned probabilities are representative of the likelihood that the discrete sections of the image include a target entity.

It was additionally noted above that the processor 106, at least in some embodiments, may also receive user state data from the one or more user state monitors 112. In such embodiments, the processor 106 appropriately processes the user data and the neurophysiological data to determine whether one or more of these data, either alone or in combination, indicate the user 101 is in a state that could adversely compromise the effectiveness of the image triage processing, which is described in more detail further below. It is noted that, based on this determination, the processor 106 may generate one or more user alerts and/or vary the pace of one or more portions of the below-described image triage processing.

The processor 106 may include one or more microprocessors, each of which may be any one of numerous known general-purpose microprocessors or application specific processors that operate in response to program instructions. In the depicted embodiment, the processor 106 includes on-board RAM (random access memory) 105, and on-board ROM (read only memory) 107. The program instructions that control the processor 106 may be stored in either or both the RAM 105 and the ROM 107. For example, the operating system software may be stored in the ROM 107, whereas various operating mode software routines and various operational parameters may be stored in the RAM 105. It will be appreciated that this is merely exemplary of one scheme for storing operating system software and software routines, and that various other storage schemes may be implemented. It will also be appreciated that the processor 106 may be implemented using various other circuits, not just one or more programmable processors. For example, digital logic circuits and analog signal processing circuits could also be used.

The image database 110 preferably has various types of imagery collections stored therein. The imagery collection types may vary, and may include, for example, various types of static imagery and various types of video imagery. It will additionally be appreciated that, although the image database 110 is, for clarity and convenience, shown as being stored separate from the processor 106, all or portions of this database 110 could be loaded into the on-board RAM 105, or integrally formed as part of the processor 106, and/or RAM 105, and/or ROM 107. The image database 110, or the image data forming portions thereof, could also be part of one or more non-illustrated devices or systems that are physically separate from the depicted system 100.

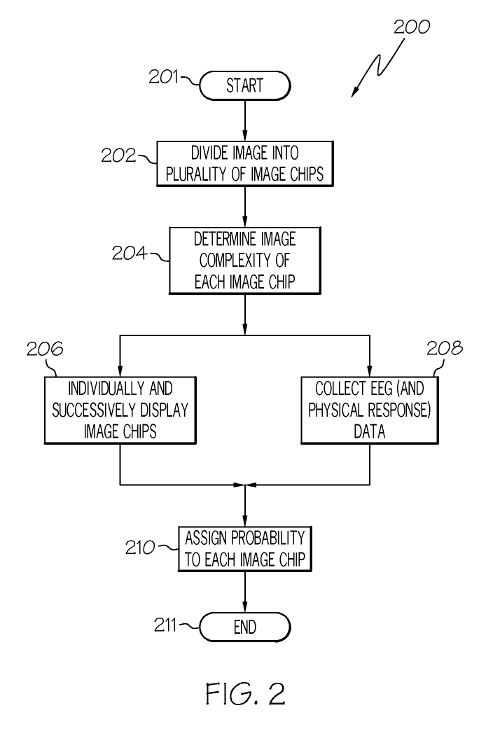

As was previously noted, the processor 106 receives either neuophysiological data, physical response data, or both, and may additionally receive user state data. The processor 106, based at least in part on one or more of these data, assigns probabilities to discrete sections of an image. These assigned probabilities are representative of the likelihood that these discrete sections of the image include a target entity. The overall process 200 by which the processor 106 implements these outcomes is depicted in flowchart form in FIG. 2, and with reference thereto will now be described in more detail. Before doing so, however, it is noted that the depicted process 200 is merely exemplary of any one of numerous ways of depicting and implementing the overall process to be described. Moreover, before the process 200 is initiated, it is noted that, if neurophysioligical data are collected, at least the neurophysiological data collector 104 has preferably been properly applied to the user 101, and appropriately configured to collect neurophysiological data. If included, the one or more user monitors 112 have also preferably been applied to the user 101, and appropriately configured to collect user state data. With this background in mind, it is additionally noted that the numerical parenthetical references in the following description refer to like steps in the flowchart depicted in FIG. 2.

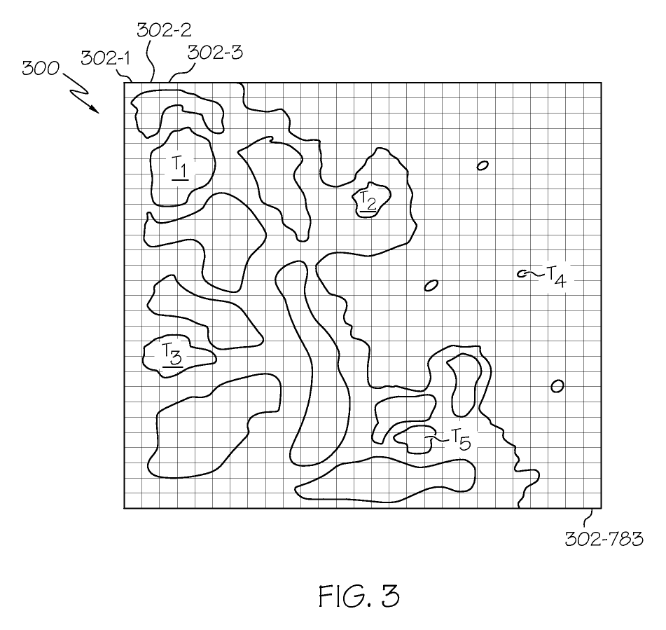

Turning now to the description of the process 200, it is seen that when an image is retrieved from the image database 110, the processor 106, and most notably the appropriate software being implemented by the processor 106, divides the retrieved image into a plurality of smaller discrete sub-images (202). More specifically, and with reference to FIG. 3, the retrieved image 300, which in the depicted embodiment is a simplified representation of a broad area image of a port region, is divided into N-number of discrete sub-images, which are referred to herein as image chips 302 (e.g., 302-1, 302-2, 302-3, . . . 302-N). It will be appreciated that the number of image chips 302 that a retrieved image 300 may be divided into may vary, and may depend, for example, on the size and/or resolution of the retrieved image 300. In the embodiment depicted in FIG. 3, the retrieved image 300 is divided into 783 image chips (i.e., N=783).

Returning once again to FIG. 2, after the image 300 has been divided into the plurality of image chips 302, the processor 106, preferably via appropriate software being implemented by the processor 106, determines the image complexity of each image chip 302 (204). The image complexity of each image chip 302 may be determined using any one of numerous known techniques. For example, one or more parameters of each image chip 302 may be statistically analyzed, or each image chip may be filtered using a suitable image filter. Some examples of suitable statistical techniques include, but are not limited to, the distribution of pixel intensity values or spatial frequency, and some non-limiting examples of suitable image filters include multi-scale color filters, and Gabor edge detector filters. For completeness, an example of the use of pixel intensity value distribution will now be described.

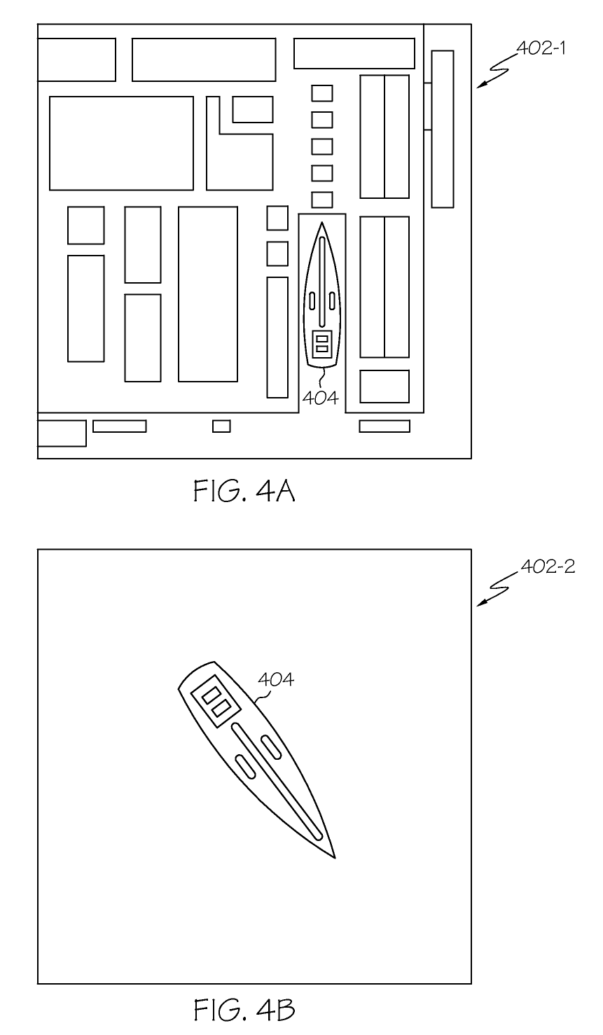

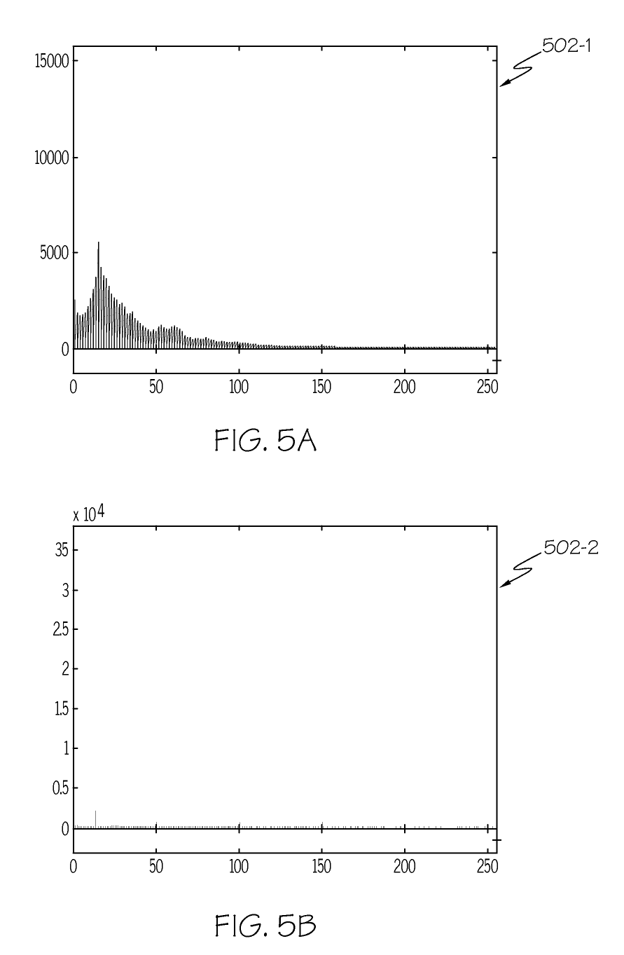

Turning to FIGS. 4A and 4B, two different exemplary image chips 402-1 and 402-2, respectively, are depicted. In both instances, the target of interest is a ship 404. The image displayed in image chip 402-1 is one of a port region, with numerous buildings and other types of distractors. Conversely, the image displayed in image chip 402-2 is of the open ocean. The image in image chip 402-1 is much more cluttered than that of image chip 402-2, making image chip 402-1 much more complex that that of image chip 402-2. Indeed, FIGS. 5A and 5B, which are pixel intensity histograms 502-1 and 502-2 for the image chips 402-1 and 402-2, respectively, clearly depict this point.

Returning once again to FIG. 2, after the image complexity of an image chip 302 has been determined (204), it is displayed on the display device 102 to the user 101 (206). Preferably, the image chips 302 are presented using a rapid serial visualization presentation (RSVP) technique. Thus, each image chip 302 is individually displayed, preferably at the same location on the display device 102, for a presentation time period, preferably in a predetermined sequence, and preferably at substantially equivalent luminance levels. However, the presentation time period of each image chip may not be equal. In particular, the presentation time period of each of the image chips 302 will vary depending on the determined image complexity of the displayed image chip 302. Thus, for example, the presentation time period of image chip 402-1 in FIG. 4A would be longer than that of image chip 402-2 in FIG. 4B. It is noted that in some embodiments the system 100 may be configured to allow the user 101 to select a baseline presentation time period via, for example, the user interface 108. However, as was just mentioned, the presentation time period may vary from the selected baseline presentation time period based on the determined image complexity of the image chip 302. Moreover, in some embodiments the presentation time period may be set and varied for groups of image chips. For example, if a group of image chips includes relatively complex images, then the presentation time period for that entire group may vary from that of another group with a relatively less number of complex images.

While the image chips 302 are being displayed to the user 101, data such as, neurophysiological data, physical response data, or both, are collected from the user 101 (208). As was noted above, in some embodiments, user state data may additionally be collected via the user interface 108 and the one or more state monitors 112, respectively. As was also previously noted, if neurophysiological data are collected, these data are preferably EEG data collected via the multi-channel EEG cap 114. It will be appreciated that, if collected, either the CCD 118 or the keyboard 122 may be used to collect the physical response data. In particular, the user 101 will hit either a predetermined button on the CCD 118 or a predetermined key on the keyboard 122 each time the user 101 believes a displayed image chip 302 includes a target entity, or at least a portion of a target entity. In the depicted embodiment, the image 300 includes five target entities that, for simplicity of illustration, are labeled T₁ through T₅ on FIG. 3. It will be appreciated that in an actual physical implementation, the image 300 may include any number of target entities, which may be, for example, various types of land vehicles, seagoing vessels, special use land masses, weapons sites, or military bases, just to name a few examples. In the remainder of the description of the process 200, it is assumed that at least neurophysiological data are collected.

During neurophysiolgical data collection, the processor 106, as previously noted, supplies image triggers, or brief pulses, to the neurophysiological data collector 104. The image triggers are supplied each time an image chip 302 is displayed. During subsequent processing, which is described further below, a segment of neuophysiological data and a segment physical response data are extracted around each image trigger. These segments, referred to as epochs, contain neuophysiological data and physical response data from a predetermined time before an image trigger to a predetermined time after the image trigger. Although the predetermined time period before and after each image trigger may vary, and concomitantly the total length of each epoch of data, in a particular preferred embodiment the predetermined time period is about 1.0 second before and after each image trigger. Thus, an epoch of neurophysiological data and an epoch of physical response data are each about 2.0 seconds in length.

After the neurophysiological data are collected and, in some embodiments, the physical response data and/or the user state data are collected, a probability is assigned to each image chip 302 (210). The probability that is assigned to each image chip 302 is based on these collected data, either alone or in combination, and is representative of the likelihood that the image chip 302 includes a target entity. It is noted that in a particular preferred embodiment, an epoch of neurophysiological data and an epoch of physical response data associated with each image chip 302 are supplied to one or more non-illustrated classifiers. The outputs of the classifiers are used to determine the probability to be assigned to each image chip 302.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended Claims.

What is claimed is:

1. A method of conducting image triage of an image that may include one or more target entities, comprising:
dividing the image into a plurality of individual image chips, each image chip having a determinable image complexity;
determining the image complexity of each image chip; and
successively displaying each image chip to a user for a presentation time period, the presentation time period for each image chip varying based on the determined image complexity of at least the image chip.

2. The method of claim 1, further comprising:
collecting data from the user at least while each image chip is being displayed; and
for each image chip, assigning a probability that the image chip at least includes a target entity, based at least in part on the collected data.

3. The method of claim 1, wherein the step of determining the image complexity of each image chip comprises statistically analyzing each image chip.

4. The method of claim 1, wherein the step of determining the image complexity of each image chip comprises filtering each image chip using an image processing filter.

5. The method of claim 1, wherein the image chips are successively displayed to the user in accordance with a rapid serial visualization (RSVP) paradigm.

6. The method of claim 1, further comprising:
collecting the data from the user from a predetermined time period before an image chip is displayed to a predetermined time period after the image chip is displayed.

7. The method of claim 1, wherein the collected data are neurophysiological data.

8. The method of claim 1, wherein the collected data are physical response data.

9. The method of claim 1, wherein the collected data are neurophysiological data and physical response data, and wherein the method further comprises:
for each image chip, assigning the probability that the image chip at least includes a target entity, based on the collected neurophysiological data and the collected physical response data.

10. The method of claim 1, further comprising:
monitoring one or more states of the user; and
supplying one or more alerts to the user based on the one or more states of the user,
wherein the monitored states of the user include one or more of user attention lapses, eye activity, and head movements.

11. A system for conducting image triage of an image that may include one or more target entities, comprising:
a display device operable to receive display commands and, in response thereto, to display an image;
a data collector configured to at least selectively collect data from a user;
processor coupled to receive the collected data from the data collector, the processor further coupled to the display device and configured to:
selectively retrieve an image,
divide the image into a plurality of individual image chips, each image chip having a determinable image complexity,
determining the image complexity of each chip, and
successively command the display device to display each image chip to a user for a presentation time period, the presentation time period for each image chip varying based on the determined image complexity of at last the image chip.

12. The system of claim 11, wherein the processor is further configured to assign a probability to each displayed image chip based at least in part on the collected data, each assigned probability representative of a likelihood that the image chip at least includes a target entity.

13. The system of claim 11, wherein the processor is configured to statistically analyze each image chip, to thereby determine the image complexity of each image chip.

14. The system of claim 11, wherein the processor is configured to implement an image processing filter, to thereby determine the image complexity of each image chip.

15. The system of claim 11, wherein the processor is further configured to successively display the image chips to the user in accordance with a rapid serial visualization (RSVP) paradigm.

16. The system of claim 11, wherein the neurological data collector is configured to collect the data from the user from a predetermined time period before an image chip is displayed to a predetermined time period after the image chip is displayed.

17. The system of claim 11, wherein the data collector comprises a neurophysiological data collector configured to at least selectively collect neurophysiological data from the user.

18. The system of claim 11, wherein the data collector comprises a user interface configured to receive input stimulus from the user and, in response thereto, to supply physical response data.

19. The system of claim 11, wherein:
the data collector comprises a neurophysiological data collector configured to at least selectively collect neurophysiological data from the user and a user interface configured to receive input stimulus from the user and, in response thereto, to supply physical response data; and
the processor is configured to assign the probability based on the collected neurophysiological data and the collected physical response data.

20. The system of claim 11, further comprising:
one or more user state monitors configured to monitoring sensor one or more states of the user and supply user state data representative thereof,
wherein:
the processor is further configured to receive the user state data, and to determine the user is in a state that could adversely compromise probability assignment effectiveness, and selectively generate one or more alerts based on the one or more states of the user, and
the states of the user include one or more of user attention lapses, eye activity, and head movements.
